(19) United States
(12) Patent Application Publication
(10) Pub. No.: US 2004/0072706 A1
(43) Pub. Date: Apr. 15, 2004

(54) Removal of contaminants using supercritical processing

(76) Inventors: Chantal J. Arena-Foster, Mesa, AZ (US); Allan Wendell Awtrey, Fort Worth, TX (US); Nicholas Alan Ryza, Austin, TX (US); Paul Schilling, Granite Bay, CA (US)

Correspondence Address: HAVERSTOCK & OWENS LLP, 162 NORTH WOLFE ROAD, SUNNYVALE, CA, 94086, US

(21) Appl. No.: 10/394,802

(22) Filed: Mar. 21, 2003

Related U.S. Application Data
(60) Provisional application No. 60/367,537, filed on Mar. 22, 2002.

(51) Int. Cl. C11D 1/00

(52) U.S. Cl. 510/175

(57) ABSTRACT

A method of cleaning a surface of an object is disclosed. The object is placed onto a support region within a pressure chamber. The pressure chamber is then pressurized. A cleaning process is performed. A series of decompression cycles are performed. The pressure chamber is then vented.

### RELATED APPLICATIONS

This Patent Application claims priority under 35 U.S.C. §119(e) of the co-pending, co-owned U.S. Provisional Patent Application, Serial No. 60/367,537, filed Mar. 22, 2002, and entitled “METHOD OF AVOIDING CONTAMINATION OF WORKPIECE AFTER SUPERCRITICAL CARBON DIOXIDE TREATMENT,” which is hereby incorporated by reference.

### FIELD OF THE INVENTION

The present invention relates to the field of removing residues and contaminants in the fabrication of semiconductor devices or other objects. More particularly, the present invention relates to the field of removing photoresist, photoresist residue, and other residues and contaminants from semiconductor wafers, substrates and other flat media requiring low contamination levels using supercritical carbon dioxide.

### BACKGROUND OF THE INVENTION

Fabrication of integrated circuits includes the formation of patterned layers on a semiconductor wafer that form electrically active regions in and on the wafer surface. As part of the manufacturing process, a masking process referred to as photolithography or photomasking is used to transfer a pattern onto the wafer. Masking involves applying a photoreactive polymer or photoresist onto the wafer by any suitable means such as by spinning of the wafer to distribute liquid photoresist uniformly on its surface. In a typical semiconductor manufacturing process, several iterations of the masking process are employed. Layers of either positive or negative photoresist can be used in various combinations on the same wafer.

Typically, the photoresist coated wafer is heated or “soft baked” to improve adhesion of the photoresist to the substrate surface. A photo aligner aligns the wafer to the photomask and then portions of the photoresist coated wafer are exposed to high-energy light so that a pattern is formed as a latent image in the photoresist layer. A developing agent is then applied to develop the portions of the photoresist which were exposed. When positive photoresist is used, the developed portions of the photoresist are solubilized by the exposure to high-energy light. Conversely, when negative photoresist is used, the undeveloped portions of the photoresist are solubilized. Washing and rinsing steps are carried out that selectively remove the solubilized photoresist. A drying step is carried out. Typically, the surface of the remaining photoresist is ultraviolet radiation hardened. An etching process is then employed in which the unprotected (i.e., not coated) substrate, dielectric or conducting layer is removed by any suitable means such as plasma ashing/etching or wet chemical etching.

When an etching process is employed in the manufacture of semiconductor devices, removal of residues and contaminants from the etched surface is desired in order to achieve high yield. The removal of the photoresist, photoresist residue and other residues and contaminants such as residual etching reactants and byproducts is commonly known as stripping. The current stripping methods include dry chemical removal methods and wet chemical removal methods. Dry removal method generally refers to a contact of a surface with a dry chemical in a gaseous plasma state to remove the residual etch process materials. Wet removal method generally refers to a contact of a surface with a liquid chemical solution.

For example, the current wet removal techniques include methods that require the semiconductor wafers be dipped into baths of chemical mixtures known as strippers. The baths can involve heat or ultrasonic augmentation. Typically, the baths employ immersion times of twenty to thirty minutes to achieve the complete removal of photoresist and photoresist residue. In other current wet removal methods, residues are removed as an agitated liquid or spray passes over a wafer surface. Current methods also can employ spinning a semiconductor wafer and simultaneously spraying a cleaning solution on the wafer to rinse a surface, and then spin-drying the wafer. Further, for example, as described in U.S. Patent Application Serial No. 09/816956, entitled “Method of Rinsing Residual Etching Reactants/Products on a Semiconductor Wafer,” the technique of spinning a wafer while spraying a cleaning solution and then spin-drying the wafer can also involve spin-drying the wafer with a nitrogen purge.

Unfortunately, dry and wet removal methods may not provide adequate removal of residues and contaminants on semiconductor device structures characterized by high aspect ratio openings, particularly when critical dimensions are in the submicron range such as below 0.25 microns. For example, as discussed in U.S. Pat. No. 6,242,165 to Vaartstra, entitled “Supercritical Compositions for Removal of Organic Material and Methods of Using Same,” issued Jun. 5, 2001, conventional stripping techniques may not be adequate for removal of hardened photoresist and/or sidewall deposited resist or residue, nor adequate for removal of residue in difficult crevices or grooves of device structures having critical dimensions below 0.25 microns. Wet stripping chemicals can be rendered ineffective as to grooves and crevices because the solvent access to the resist or residue to be removed is limited by reason of surface tension and capillary actions. Dry techniques may also fail to completely remove resist or residue in grooves and crevices because sidewall polymer formations that occur as a result of the interaction of plasma etching by-products with the sidewalls of the structure are not easily removed using plasma ashing processes, as described in the '165 patent.

Various process steps in semiconductor manufacturing have a tendency to increase the difficulty in the removal of photoresist. For example, surface hardening of photoresist by reactive ion etching or ion implantation processes increases the difficulty in the removal of resist or residue. Further, for example, soft bake and ultraviolet radiation hardening steps may cause chemical changes in the photoresist that increase the difficulty in the removal of residue and contaminants using the current stripping methods.

Other problems associated with the current stripping methods include the cost of water and chemicals, pressure on the semiconductor industry from environmental groups, and employee lawsuits that allege clean-room jobs cause health problems. Thus, there is considerable interest in the semiconductor manufacturing field for developing more efficient and ecofriendly stripping methods to decrease the safety hazards and to reduce the volume of chemicals and water used in the manufacture of semiconductor devices.

### Supercritical Fluids

A fluid in the supercritical state is referred to as a supercritical fluid. A fluid enters the supercritical state when it is subjected to a combination of pressure and temperature at which the density of the fluid approaches that of a liquid. Supercritical fluids are characterized by high solvating and solubilizing properties that are typically associated with compositions in the liquid state. Supercritical fluids also have a low viscosity that is characteristic of compositions in the gaseous state.

Supercritical fluids have been used to remove residue from surfaces or extract contaminants from various materials. For example, as described in U.S. Pat. No. 6,367,491 to Marshall, et al., entitled “Apparatus for Contaminant Removal Using Natural Convection Flow and Changes in Solubility Concentration by Temperature,” issued Apr. 9, 2002, supercritical and near-supercritical fluids have been used as solvents to clean contaminants from articles; citing, NASA Tech Brief MFS-29611 (December 1990), describing the use of supercritical carbon dioxide as an alternative for hydrocarbon solvents conventionally used for washing organic and inorganic contaminants from the surfaces of metal parts.

Supercritical fluids have been employed in the cleaning of semiconductor wafers. For example, an approach to using supercritical carbon dioxide to remove exposed organic photoresist film is disclosed in U.S. Pat. No. 4,944,837 to Nishikawa, et al., entitled “Method of Processing an Article in a Supercritical Atmosphere,” issued Jul. 31, 1990. There remains a need for more effective and cost efficient stripping methods using supercritical carbon dioxide to remove a wide range of organic and inorganic materials such as high molecular weight non-polar and polar compounds, along with ionic compounds, in the manufacture of semiconductor devices and other objects.

What is needed is a more effective and efficient method of removing photoresist, photoresist residue, and other residues and contaminants such as residual etching reactants and byproducts from semiconductor wafers, substrates and other flat media requiring low contamination levels using supercritical carbon dioxide.

### SUMMARY OF THE INVENTION

A first embodiment of the present invention is for a method of cleaning a surface of an object. The object is placed onto a support region within a pressure chamber. The pressure chamber is then pressurized. A cleaning process is performed. A series of decompression cycles are performed. The pressure chamber is then vented.

A second embodiment of the invention is for a method of removing a contaminant from a surface of an object. The object is placed onto a support region within a pressure chamber. The pressure chamber is then pressurized. A cleaning process is performed. The pressure chamber is then pressurized to push a cleaning chemistry out of the pressure chamber. A series of decompression cycles are performed. The pressure chamber is then vented.

A third embodiment is for a method of removing a contaminant from a surface of a semiconductor wafer. The wafer is placed onto a support region within a pressure chamber. The pressure chamber is then pressurized to a first pressure sufficient to form a supercritical fluid. A cleaning chemistry is injected into the pressure chamber. The pressure of the pressure chamber is increased to a second pressure. The cleaning chemistry is recirculated within the pressure chamber. The pressure of the pressure chamber is increased to push the cleaning chemistry out of the pressure chamber. A series of decompression cycles are performed. The pressure chamber is then vented.

A fourth embodiment is for an apparatus for removing a contaminant from a surface of an object. A pressure chamber including an object support. Means for pressurizing the pressure chamber. Means for performing a cleaning process. Means for performing a series of decompression cycles. Means for venting the pressure chamber.

### BRIEF DESCRIPTION OF THE DRAWINGS

The present invention may be better understood by reference to the accompanying drawings of which:

FIG. 1 is a flow chart showing a process flow for a method of cleaning a surface of an object in accordance with the present invention.

FIG. 2 is a flow chart illustrating a cleaning process (30a) corresponding to the perform cleaning process (30) of process flow (100) as shown in FIG. 1.

FIG. 3 is a flow chart illustrating a cleaning process (30b) also corresponding to the perform cleaning process (30) as shown in FIG. 1.

FIG. 4 is a pressure/time graph for purpose of illustrating a method of the present invention.

### DETAILED DESCRIPTION OF THE PREFERRED EMBODIMENTS

The following detailed description with reference to the accompanying drawings is illustrative of various embodiments of the invention. The present invention should not be construed as limited to the embodiments set forth herein. Therefore, the following detailed description is not to be taken in a limiting sense, and the scope of the present invention is defined by the accompanying claims.

The present invention is directed to a process of cleaning a surface of an object, such as a semiconductor substrate that has been subjected to an etching process in accordance with methods well known in the art of manufacturing semiconductor devices.

The removal of the photoresist, photoresist residue and other residues and contaminants such as residual etching reactants and byproducts is commonly known as stripping. Current stripping techniques may not provide adequate removal of hardened photoresist and/or sidewall deposited resist or residue, or residues and contaminants in difficult crevices or grooves of device structures, particularly when critical dimensions are in the submicron range. For example, wet chemical methods can be rendered ineffective as to grooves and crevices because the solvent access to the resist or residue to be removed is limited by reason of surface tension and capillary actions. Semiconductor manufacturing processes such as surface hardening of photoresist by ultraviolet radiation, reactive ion etching or ion implantation have a tendency to increase the difficulty in the removal of residue and contaminants using the current stripping methods.

To overcome the problems of removal of photoresist, photoresist residue and other residues and contaminants such as residual etching reactants and byproducts encountered in the prior art, more efficient and ecofriendly cleaning processes and apparatus have been developed to decrease the safety hazards and to reduce the volume of chemicals and water used in the manufacture of semiconductor devices and other objects. The methods and apparatus in accordance with the present invention utilize the low viscosity and high solvating and solubilizing properties of supercritical carbon dioxide to assist in the cleaning process.

For purposes of the invention, “carbon dioxide” should be understood to refer to carbon dioxide (CO₂) employed as a fluid in a liquid, gaseous or supercritical (including near-supercritical) state. “Liquid carbon dioxide” refers to CO₂ at vapor-liquid equilibrium conditions. If liquid CO₂ is used, the temperature employed is preferably below 30.5° C. “Supercritical carbon dioxide” refers herein to CO₂ at conditions above the critical temperature (30.5° C.) and critical pressure (7.38 MPa). When CO₂ is subjected to pressures and temperatures above 7.38 MPa and 30.5° C., respectively, it is determined to be in the supercritical state. “Near-supercritical carbon dioxide” refers to CO₂ within about 85% of absolute critical temperature and critical pressure.

The liquid or supercritical carbon dioxide may, in a preferred embodiment, be provided as a composition. Liquid or supercritical CO₂ compositions preferred for use in the methods and apparatus of the present invention may include supercritical CO₂ and a cleaning chemistry. Preferably, the cleaning chemistry enhances the properties of the supercritical CO₂ to promote association of the amphiphilic species with the contaminant and to remove the contaminant in the chemical-laden supercritical CO₂. It should be appreciated that in the embodiments wherein a composition is provided the principle constituent of the composition of the present invention is liquid or supercritical CO₂.

Various objects can be cleaned using the processes and apparatus of the present invention such as substrates and other flat media. For the purposes of the invention, “cleaning” should be understood to be consistent with its conventional meaning in the art. As used herein, “substrate” includes a wide variety of structures such as semiconductor device structures with a deposited photoresist or residue. A substrate can be a single layer of material, such as a silicon wafer, or can include any number of layers. A substrate can be comprised of various materials, including metals, ceramics, glass, or compositions thereof.

A wide variety of materials can be effectively removed using the methods and apparatus of the invention. For example, photoresist, photoresist residue, carbon-fluorine containing polymers such as those resulting from oxide etching processes or plasma etch processes, and other residues and contaminants such as residual etching reactants and byproducts can be removed according to the present invention. The methods and apparatus of the invention are particularly advantageous for the removal of ultraviolet radiation hardened photoresist, reactive ion etching or ion implantation hardened resist, and residues and contaminants in crevices or grooves of device structures having critical dimensions below 0.25 microns.

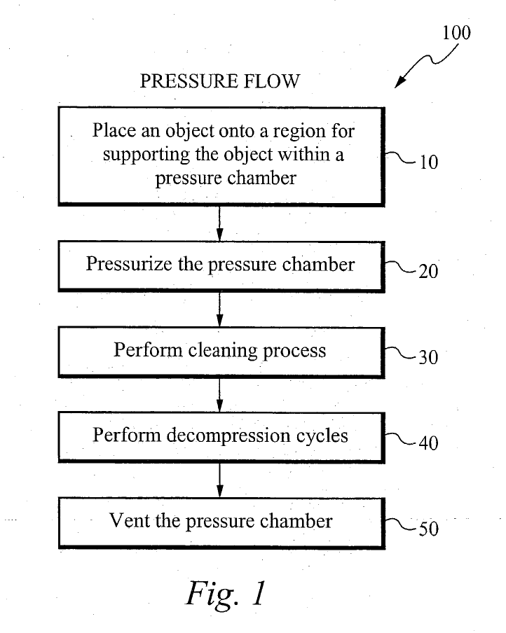

FIG. 1 shows a process flow (100) for a method of cleaning a surface of an object in accordance with the present invention. The object is placed onto a support region within a pressure chamber (10). The pressure chamber is then pressurized (20). A cleaning process is performed (30). A series of decompression cycles are performed (40). The pressure chamber is then vented to atmospheric pressure (50).

The pressure chamber may be pressurized (20) with gaseous, liquid, supercritical or near-supercritical CO₂. Preferably, the pressure chamber is pressurized (20) with CO₂ to 2500 psi.

Preferably, the temperature range used for process flow (100) is in the range of approximately 30° C. to 250° C. In one preferred embodiment, the temperature of the support region within the pressure chamber is maintained to minimize condensation on the object. In order to minimize condensation on the object, preferably the temperature of the support region is higher than the CO₂ within the pressure chamber. More preferably, the temperature of the support region within the pressure chamber is maintained at approximately 65° C.

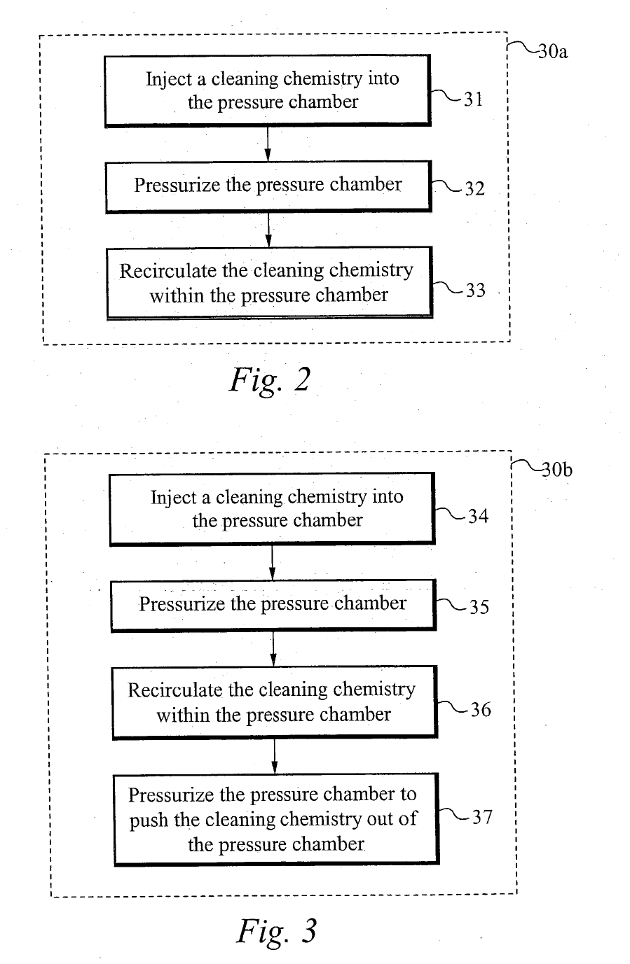

FIG. 2 is a flow chart illustrating a cleaning process (30a), which corresponds to the perform cleaning process (30) of process flow (100), as shown in FIG. 1. The cleaning process (30a) comprises the injection of a cleaning chemistry into the pressure chamber (31), pressurization of the pressure chamber (32), and recirculating the cleaning chemistry within the pressure chamber (33).

The pressure chamber can be pressurized (32) with gaseous, liquid, supercritical or near-supercritical carbon dioxide. Preferably, the pressure chamber is pressurized (32) with carbon dioxide to 2800 psi. The recirculation of the cleaning chemistry within the pressure chamber (33), in a preferred embodiment, is for a period of time to remove a contaminant. For the purposes of the present invention, “contaminant” refers to a wide range of organic and inorganic materials such as high molecular weight non-polar and polar compounds, along with ionic compounds, photoresist, photoresist residue and other residues such as residual etching reactants and byproducts, or a combination thereof. Preferably, the period of time to remove a contaminant is approximately three minutes. More preferably, the period of time is approximately two minutes. It should be appreciated that in the embodiments wherein a cleaning chemistry is recirculated within a pressure chamber for a period of time to remove a contaminant, “a contaminant” refers to at least a portion of a contaminant.

Performing a series of decompression cycles (40), as shown in FIG. 1, preferably comprises performing at least two decompression cycles. More preferably, performing a series of decompression cycles (40) comprises performing a series of decompression cycles (40) such that the pressure of the pressure chamber remains above a supercritical pressure. Still more preferably, performing a series of decompression cycles (40) comprises performing a series of decompression cycles such that each of the decompression cycles starts from approximately 2900 psi and goes down to approximately 2500 psi. It should be appreciated that in the embodiments wherein decompression cycles are employed, “decompression cycles” refers to decompression-and-compression cycles.

FIG. 3 is a flow chart illustrating a cleaning process (30b) also corresponding to the perform cleaning process (30) of process flow (100), as shown in FIG. 1. The cleaning process (30b) comprises the injection of a cleaning chemistry into the pressure chamber (34), pressurization of the pressure chamber (35), recirculating the cleaning chemistry within the pressure chamber (36), and pressurizing the pressure chamber to push the cleaning chemistry out of the pressure chamber (37). The pressure chamber can be pressurized with gaseous, liquid, supercritical or near-supercritical carbon dioxide. Preferably, the pressure chamber is pressurized with CO₂ to 3000 psi to push the cleaning chemistry out of the pressure chamber (37).

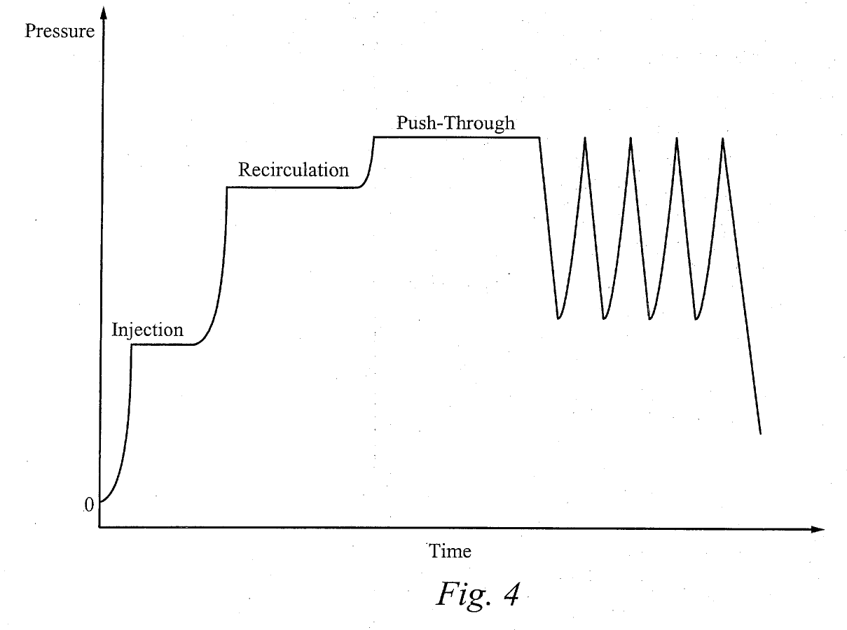

FIG. 4 illustrates a method of removing a contaminant from a surface of a semiconductor wafer in accordance with the present invention. The wafer is placed onto a support region within a pressure chamber. The pressure chamber is then pressurized to a first pressure sufficient to form a supercritical fluid. A cleaning chemistry is injected into the pressure chamber. The pressure of the pressure chamber is increased to a second pressure. The cleaning chemistry is recirculated within the pressure chamber. The pressure of the pressure chamber is increased to push the cleaning chemistry out of the pressure chamber. A series of decompression cycles are performed. The pressure chamber is then vented.

Another preferred embodiment is an apparatus for removing a contaminant from a surface of an object. The apparatus includes a high pressure processing chamber (“pressure chamber”) including an object support. The details concerning the pressure chamber are disclosed in co-owned and co-pending U.S. patent applications, Ser. No. 09/912,844, entitled “HIGH PRESSURE PROCESSING CHAMBER FOR SEMICONDUCTOR SUBSTRATE,” filed Jul. 24, 2001, and Ser. No. 09/970,309, entitled “A HIGH PRESSURE PROCESSING CHAMBER FOR MULTIPLE SEMICONDUCTOR SUBSTRATES,” filed Oct. 3, 2001, which are hereby incorporated by reference. Liquid or supercritical carbon dioxide is provided into the pressure chamber by means of a liquid or supercritical CO₂ supply vessel coupled to the pressure chamber via a CO₂ pump and piping. The liquid or supercritical CO₂ can be pre-pressurized. It should be appreciated that in the embodiment wherein a composition is provided, additional components can be employed to provide a cleaning chemistry. A means is provided for pressurizing the pressure chamber such as a pump. A means is provided for performing a cleaning process. A means is provided for performing a series of decompression cycles. A means is provided for venting the pressure chamber. In one embodiment, the liquid or supercritical CO₂ is recycled to provide a closed system.

The invention methods and apparatus for removing a contaminant from a surface of an object are more efficient and ecofriendly cleaning processes and apparatus to decrease the safety hazards and reduce the volume of chemicals and water used in the manufacture of semiconductor devices and are absolutely compatible with wafer metallizations used as conductive layers and substrates.

While the processes and apparatus of this invention have been described in detail for the purpose of illustration, the inventive processes and apparatus are not to be construed as limited thereby. It will be readily apparent to those of reasonable skill in the art that various modifications to the foregoing preferred embodiments can be made without departing from the spirit and scope of the invention as defined by the appended claims.

1. A method of cleaning a surface of an object comprising:
a. placing the object onto a support region within a pressure chamber;
b. pressurizing the pressure chamber;
c. performing a cleaning process;
d. performing a series of decompression cycles; and
e. venting the pressure chamber.

2. The method of claim 1 wherein the object is a substrate being selected from the group consisting of metals, ceramics, glass, and composite mixtures thereof.

3. The method of claim 1 wherein a temperature of the support region within the pressure chamber is maintained to minimize condensation on the object.

4. The method of claim 3 wherein pressurizing the pressure chamber comprises pressurizing the pressure chamber with gaseous, liquid, supercritical or near-supercritical carbon dioxide and wherein the temperature of the support region within the pressure chamber is higher than the carbon dioxide.

5. The method of claim 3 wherein the temperature of the support region within the pressure chamber is maintained at approximately 65° C.

6. The method of claim 1 wherein the surface of the object supports a photoresist residue.

7. The method of claim 1 wherein the surface of the object supports a residual etching reactant/byproduct.

8. The method of claim 1 wherein pressurizing the pressure chamber comprises pressurizing the pressure chamber with gaseous, liquid, supercritical or near-supercritical carbon dioxide.

9. The method of claim 8 wherein pressurizing the pressure chamber with carbon dioxide comprises pressurizing the pressure chamber with carbon dioxide to 2500 psi.

10. The method of claim 1 wherein performing a cleaning process comprises:
a. injecting a cleaning chemistry into the pressure chamber;
b. pressurizing the pressure chamber; and
c. recirculating the cleaning chemistry within the pressure chamber.

11. The method of claim 10 wherein pressurizing the pressure chamber comprises pressurizing the pressure chamber with gaseous, liquid, supercritical or near-supercritical carbon dioxide.

12. The method of claim 11 wherein pressurizing the pressure chamber with carbon dioxide comprises pressurizing the pressure chamber with carbon dioxide to 2800 psi.

13. The method of claim 10 wherein recirculating the cleaning chemistry within the pressure chamber comprises recirculating the cleaning chemistry within the pressure chamber for a period of time to remove a contaminant from a surface of the object.

14. The method of claim 13 wherein a period of time equals approximately three minutes.

15. The method of claim 13 wherein a period of time equals approximately two minutes.

16. The method of claim 10 wherein performing a cleaning process further comprises pressurizing the pressure chamber to push the cleaning chemistry out of the pressure chamber.

17. The method of claim 16 wherein pressurizing the pressure chamber to push the cleaning chemistry out of the pressure chamber comprises pressurizing the pressure chamber with gaseous, liquid, supercritical or near-supercritical carbon dioxide to push the cleaning chemistry out of the pressure chamber.

18. The method of claim 17 wherein pressurizing the pressure chamber with carbon dioxide comprises pressurizing the pressure chamber with carbon dioxide to 3000 psi.

19. The method of claim 1 wherein performing a series of decompression cycles comprises performing at least two decompression cycles.

20. The method of claim 1 wherein performing a series of decompression cycles comprises performing a series of decompression cycles such that each of the decompression cycles starts from approximately 2900 psi and goes down to approximately 2500 psi.

21. The method of claim 1 wherein performing a series of decompression cycles comprises performing a series of decompression cycles such that the pressure chamber remains above a supercritical pressure.

22. A method of removing at least a portion of a material selected from the group consisting of a photoresist, a photoresist residue, a residual etching reactant/byproduct, and a combination thereof, from a surface of an object comprising:
a. placing the object onto a support region within a pressure chamber;
b. pressurizing the pressure chamber;
c. performning a cleaning process;
d. performing a series of decompression cycles; and
e. venting the pressure chamber.

23. A method of removing a contaminant from a surface of an object comprising:
a. placing the object onto a support region within a pressure chamber;
b. pressurizing the pressure chamber;
c. performing a cleaning process;
d. pressurizing the pressure chamber to push a cleaning chemistry out of the pressure chamber;
e. performing a series of decompression cycles; and
f. venting the pressure chamber.

24. A method of removing a contaminant from a surface of a semiconductor wafer comprising the steps of:
a. placing the wafer onto a support region within a pressure chamber;
b. pressurizing the pressure chamber to a first pressure sufficient to form a supercritical fluid;
c. injecting a cleaning chemistry into the pressure chamber;
d. increasing a pressure of the pressure chamber to a second pressure;
e. recirculating the cleaning chemistry within the pressure chamber;
f. increasing a pressure of the pressure chamber to push the cleaning chemistry out of the pressure chamber
g. performing a series of decompression cycles; and
h. venting the pressure chamber.

25. The method of claim 24 wherein series of decompression cycles are performed such that the pressure chamber remains above a supercritical pressure.

26. An apparatus for removing a contaminant from a surface of an object comprising:
a. pressure chamber including an object support;
b. means for pressurizing the pressure chamber;
c. means for performing a cleaning process;
d. means for performing a series of decompression cycles; and
e. means for venting the pressure chamber.

27. The apparatus of claim 26 wherein the object is a substrate being selected from the group consisting of metals, ceramics, glass, and composite mixtures thereof.

28. The apparatus of claim 26 wherein a temperature of means for supporting the object is maintained to minimize condensation on the object.

29. The apparatus of claim 26 wherein means for pressurizing the pressure chamber comprises means for pressurizing the pressure chamber with gaseous, liquid, supercritical or near-supercritical carbon dioxide and wherein the temperature of means for supporting the object is higher than the carbon dioxide.

30. The apparatus of claim 26 wherein the contaminant is a photoresist residue.

31. The apparatus of claim 26 wherein the contaminant is a residual etching reactant/byproduct.

32. The apparatus of claim 26 wherein means for pressurizing the pressure chamber comprises means for pressurizing the pressure chamber with gaseous, liquid, supercritical or near-supercritical carbon dioxide.

33. The apparatus of claim 32 wherein means for pressurizing the pressure chamber with carbon dioxide comprises means for pressurizing the pressure chamber with carbon dioxide to 2500 psi.

34. The apparatus of claim 26 wherein means for performing a cleaning process comprises:
a. means for injecting a cleaning chemistry into the pressure chamber;
b. means for pressurizing the pressure chamber; and
c. means for recirculating the cleaning chemistry.

35. The apparatus of claim 34 wherein means for pressurizing the pressure chamber comprises means for pressurizing the pressure chamber with gaseous, liquid, supercritical or near-supercritical carbon dioxide.

36. The apparatus of claim 35 wherein means for pressurizing the pressure chamber with carbon dioxide comprises pressurizing the pressure chamber with carbon dioxide to 2800 psi.

37. The apparatus of claim 34 wherein means for recirculating the cleaning chemistry comprises means for recirculating the cleaning chemistry for a period of time to remove the contaminant from a surface of the object.

38. The apparatus of claim 37 wherein a period of time equals approximately three minutes.

39. The apparatus of claim 37 wherein a period of time equals approximately two minutes.

40. The apparatus of claim 34 wherein means for performing a cleaning process further comprises means for pressurizing the pressure chamber to push the cleaning chemistry out of the pressure chamber.

41. The apparatus of claim 40 wherein means for pressurizing the pressure chamber to push the cleaning chemistry out of the pressure chamber comprises means for pressurizing the pressure chamber with gaseous, liquid, supercritical or near-supercritical carbon dioxide to push the cleaning chemistry out of the pressure chamber.

42. The apparatus of claim 41 wherein means for pressurizing the pressure chamber with carbon dioxide comprises means for pressurizing the pressure chamber with carbon dioxide to 3000 psi.

43. The apparatus of claim 26 wherein means for performing a series of decompression cycles comprises means for performing at least two decompression cycles.

44. The apparatus of claim 26 wherein means for performing a series of decompression cycles comprises means for performing a series of decompression cycles such that each of the decompression cycles starts from approximately 2900 psi and goes down to approximately 2500 psi.

45. The apparatus of claim 26 wherein means for performing a series of decompression cycles comprises means for performing a series of decompression cycles such that the pressure chamber remains above a supercritical pressure.
